(19) United States
(12) Patent Application Publication
(10) Pub. No.: US 2007/0079542 A1
(43) Pub. Date: Apr. 12, 2007

(54) Fishing sinker

(75) Inventor: Theodore A. Takasaki, East Gull Lake, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(73) Assignee: Lindy-Little Joe, Inc.

(21) Appl. No.: 11/247,460

(22) Filed: Oct. 11, 2005

(51) Int. Cl. A01K 95/00

(52) U.S. Cl. 43/44.9

(57) ABSTRACT

A center slide slip sinker for fishing having a buoyant portion, a weighted portion and a hollow tubular member extending from one end to the other.

### BACKGROUND OF THE INVENTION

1. Field of the Invention

The present invention relates generally to a fishing sinker and a method of making the same, and more specifically to a center slide slip sinker with a configuration which enables the sinker to be substantially snag-free while at the same time providing desired action to the bait or trailing smell and providing the angler with a better feel of the bottom. The invention also relates to a method of making such a fishing sinker.

2. Description of the Prior Art

A variety of fishing sinkers or weights currently exist in the art. These sinkers function primarily to provide weight to a fishing line for the purpose of causing the fishing line and the attached bait or lure to sink below the water surface. A variety of sinker configurations exist. Some sinkers are designed for attachment to the fishing line at a fixed position. Others, commonly referred to as slip sinkers, are allowed to slip or slide along the fishing line within certain limits. For the most part, these sinkers are constructed of a heavy metal or other material to provide sinker with the necessary weight. Lead or lead alloys are materials commonly used in the manufacture of currently available fishing sinkers. Some, however, such as the sinkers of the LaForce U.S. Pat. No. 3,859,906, the Wohead U.S. Pat. No. 4,693,030, the Foster U.S. Pat. No. 3,012,359, the Miller U.S. Pat. No. 5,303,499 and the Adams U.S. Pat. No. 6,145,240, among others, disclose sinkers with buoyant capability.

Although the current fishing sinkers adequately provide the function of causing the fishing line and attached bait or lure to sink below the water surface as desired, the sinkers of the prior art comprise multiple parts and/or often become snagged or hung up, particularly in fishing areas with rocks, brush, weed beds or stump fields. As a result, many of these snag infested fishing waters are considered “off limits” with certain conventional sinkers.

Accordingly, there is need in the art for a new fishing sinker and in particular a new center side slip sinker, which is of a substantially unitary structure and is substantially snag-free or which substantially reduces the frequency of the sinker from becoming snagged in rocks, brush, weed beds, stump fields and the like. A need also exists for a method of making such a fishing sinker.

### SUMMARY OF THE INVENTION

In contrast to the prior art, the fishing sinker of the present invention is a center slide slip sinker which has a substantially unitary construction and configuration. The sinker is substantially snag-free and provides the angler with a better feel of the bottom during use and without tumbling or twisting, while still providing a desired degree of wobble or action to the bait or trailing smell.

More specifically, the fishing sinker of the present invention is a center slide slip sinker which includes a substantially unitary body. The body comprises a weighted portion with a density greater than water and a buoyant portion with a density less than that of water. In a preferred construction, the body is elongated with a rod end and a bait end, and is provided with a centrally positioned fishing line opening extending from the rod end to the bait end. The buoyant portion of the body is positioned near the rod end so that when the sinker is immersed in water, the rod end is more buoyant than the bait end.

Preferably, the elongated configuration of the sinker of the present invention is curved or includes a curved portion which, either individually or in combination with the buoyant portion of the body, increases the snag resistant ability of the sinker. With the curved configuration and the buoyant and weighted portion balance of the sinker of the present invention, the sinker tends to lift, pivot and right itself as it wiggles through, over and around snags, while at the same time preventing the sinker from flopping or tumbling during a cast and from spinning or twisting during use.

The method aspect of the present invention relates to a method of making the sinker of the present invention and includes the step of providing a center tube member and forming or providing the buoyant and weighted portions of the body around the tube member. In the preferred method, the tube is inserted through the buoyant portion and the weighted portion is molded or cast around the tube.

Accordingly, it is an object of the present invention to provide a fishing slip sinker which is substantially snag-free or which substantially reduces snags in comparison to sinkers of the prior art.

Another object of the present invention is to provide a slip sinker having a substantially unitary body with a buoyant portion having a density less than that of water and a weighted portion having a density greater than that of water.

Another object of the present invention is to provide a fishing sinker with a body formed or molded around an elongated centrally positioned tubular member with a rod end and a bait end.

A still further object of the present invention is to provide a center slide slip sinker with a buoyant portion and a weighted portion.

Another object of the present invention is to provide a method of making the fishing sinker described above.

These and other objects of the present invention will become apparent with reference to the drawings, the description of the preferred embodiment and the appended claims.

### DESCRIPTION OF THE DRAWINGS

FIG. 1 is a side elevational side view of the fishing sinker of the present invention.

FIG. 2 is a view, partially in section, as cut along the center axis of the sinker of the present invention as viewed from the same direction as that of FIG. 1.

FIG. 3 is a view, partially in section, as cut along the center axis of the sinker of the present invention as viewed along the section line 3-3 of FIG. 1.

FIG. 4 is a view, partially in section, as viewed along the section line 4-4 of FIG. 1.

FIG. 5 is a view, partially in section, as viewed along the section line 5-5 of FIG. 1.

FIG. 6 is an elevational view showing a first step in the method of making the fishing sinker of the present invention.

FIG. 7 is a view, partially in section, of a further step in the method of making the fishing sinker of the present invention.

FIG. 8 is a view, partially in section, of a further step in the method of making the fishing sinker of the present invention.

FIG. 9 is a view, partially in section, of a further step in the method of making the fishing sinker of the present invention.

FIG. 10 is a elevational view of a preforming wire usable in the method of making the fishing sinker of the present invention.

### DESCRIPTION OF THE PREFERRED EMBODIMENT AND METHOD

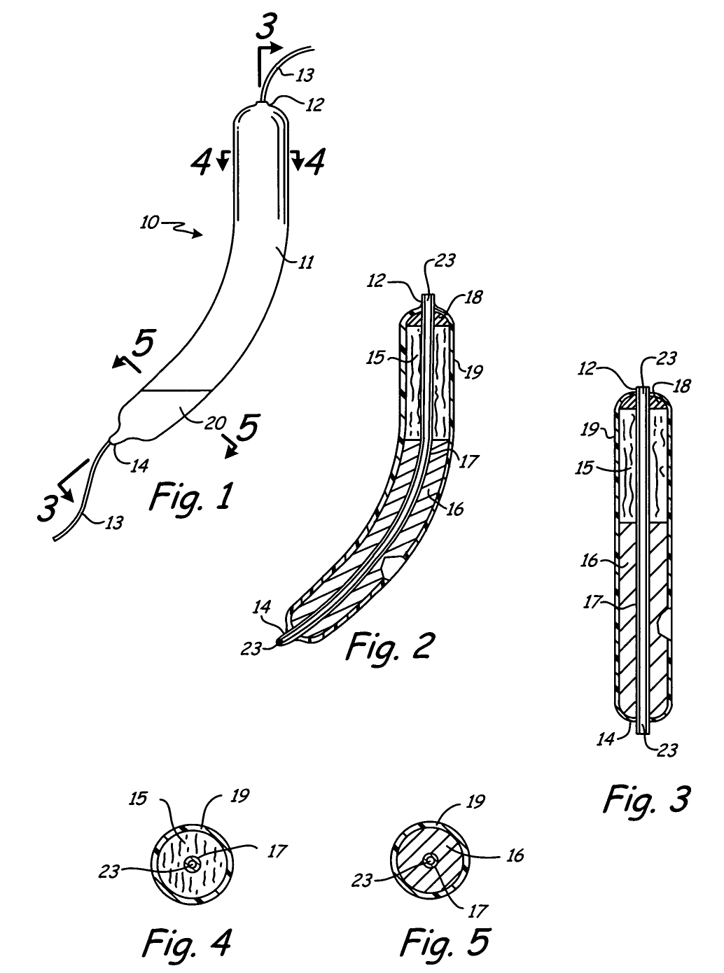

With reference to FIG. 1, the fishing sinker 10 of the present invention includes an elongated, banana-shaped body 11 having a first or rod end 12 and a second or bait end 14. A centrally positioned tubular member 17 (FIGS. 2 and 3) with a line receiving opening 23 extends from the end 12 to the end 14. When in use, a fishing line 13 extends through the opening 23, the rod end 12 of the sinker 10 faces the fishing rod (not shown) and the bait end 14 faces the bait or lure (not shown).

In the preferred embodiment, the body 11 is elongated and has a center axis extending from the first or rod end 12 to the second or bait end 14. The body is elongated in the direction of the center axis and includes a length dimension measured from the rod end 12 to the bait end 14 along the center axis and a width dimension measured in a direction perpendicular to the center axis and at a point about mid-way between the rod and bait ends 12 and 14, respectfully. The cross sectional configuration in width dimension of the body 11 can vary along the length of the body, however, in the preferred embodiment, the cross sectional configuration is substantially circular as shown in FIGS. 4 and 5 and is substantially consistent or the same throughout substantially the entire length of the body. Preferably, the body 11 has an elongation such that the length dimension is at least about three times the width dimension, more preferably at least five times the width dimension and most preferably about 5-15 times the width dimension.

The sinker in accordance with the present invention has particular application to lake and river fishing in which the sinker has a weight less than 10 ounces. and more preferably less than 5 ounces The length dimension of such a sinker is preferably less than about 15 inches, more preferably less than about 10 inches and most preferably less than about 5 inches. The preferred width dimension of the sinker of the present invention is less than about 1 inch and more preferably less than about ½ inch.

Although some snag resistance is experienced by a body II which is substantially straight, improved snag resistance is experienced when the elongated body 11 is provided with a bend or curvature as shown in FIGS. 1 and 2. Such a bend or curvature enables the sinker to twist itself free from obstructions and enables the sinker to glide through the water without tumbling or twisting, while at the same time providing the bait or trailing smell with a desired degree of wobble.

The specific structure of the sinker of the present invention is shown best in FIGS. 2, 3, 4 and 5. As shown, the body includes a buoyant potion 15 having a density less than the density of water and a weighted portion 16 having a density greater than the density of water. In the preferred embodiment, the buoyant portion 15 is positioned at or near the rod end 12 of the body, while the weighted portion 16 is positioned at or near the bait end 14 of the body. The volume or amount of the buoyant portion 15 compared to the weighted portion 16 assists in defining the balance of the sinker in accordance with the present invention. Preferably the buoyant portion 15 comprises about 10-60 percent of the volume of the volume of the body 11, more preferably about 15-50 percent of the body 11, and most preferably about 20-40 percent of the volume of the body 11.

Although the buoyant portion 15 can extend to and define the rod end 12 of the body 11, the preferred embodiment includes a short, second weighted portion 18 positioned at the rod end 12 and having a density greater than that of water. Preferably, the weighted portion 18 and the weighted portion 16 are constructed of the same material. In the preferred embodiment, the weighted portion 22 functions primarily to anchor and stabilize the rod end of the center tube 17 and to prevent water from reaching the buoyant portion 20. In the preferred embodiment, the weighted portion 18 extends no more than about a quarter of an inch from the rod end 12.

The buoyant portion 20 can be constructed of a variety of buoyant materials as long as the material has a density less than that of water, and is thus buoyant in water. Synthetic materials such as Styrofoam or other plastics can be used, however, the material of the preferred embodiment is balsa wood.

The weighted portion 16 and the weighted portion 18 can also be constructed of a variety of materials, provided such materials have a density greater than that of water. Preferably, the material is a heavy material such a lead, lead alloys or antimony/lead. In the preferred embodiment, the buoyant portion 15 and the weighted portions 16 and 18 are fixed to one another to form a rigid, unitary structure and are thus not capable of being detached from one another without destroying the sinker. Further, the weight of the sinker is fixed and is not capable of being varied.

The existence of the buoyant portion 15 relative to the weighted portion 16 provides an upward or lifting force to the top part of the sinker body when the sinker is in the water. With this structure, improved snag resistance is achieved.

With continued reference to FIGS. 2-5, the sinker is provided with an elongated, centrally positioned tubular member 17 extending the length of the body 11 from the rod end 12 to the bait end 14. Preferably, this tubular member 15 extends along the center axis of the body 11. This tubular member 17 has a hollow center which provides an opening 23 extending through the sinker from the rod end 12 to the bait end 14. In the preferred embodiment, the tubular member 17 is constructed of a polyvinyl chloride (PVC) plastic material with the central opening 23 being sufficiently large to permit the free, unobstructed passage of a fishing line 13 (FIG. 1).

In the preferred embodiment, the entire body is dip coated or otherwise provided with a plastic coating 19. Preferably, this dip coating is a plastic vinyl material which serves three primary functions: first, it functions to seal the entire interior of the body 11 to prevent the buoyant material 15 from becoming water logged; second, it provides a smooth outer surface to the sinker to make it more snag resistant; and third, it functions to hold all of the body components and the tubular member together to form a unitary structure. In addition to the existence of the plastic dip coating 19, the sinker can be painted one or more colors and/or coats of paint to provide a sinker desired color. Further, the exterior of the sinker can be provided with a change in color or other marking 20 to identify the top and bottom or rod and bait ends of the sinker.

According to the preferred embodiment, the sinker of the present invention is unitary (i.e., is in one piece) and is of a fixed weight and size. In other words, the sinker of the present invention is free of any means for varying the size or weight of the sinker. Further, the sinker preferably has a body of a buoyant portion and a connected weighted portion, with the entire body being relatively rigid and provided with a vinyl or other coating.

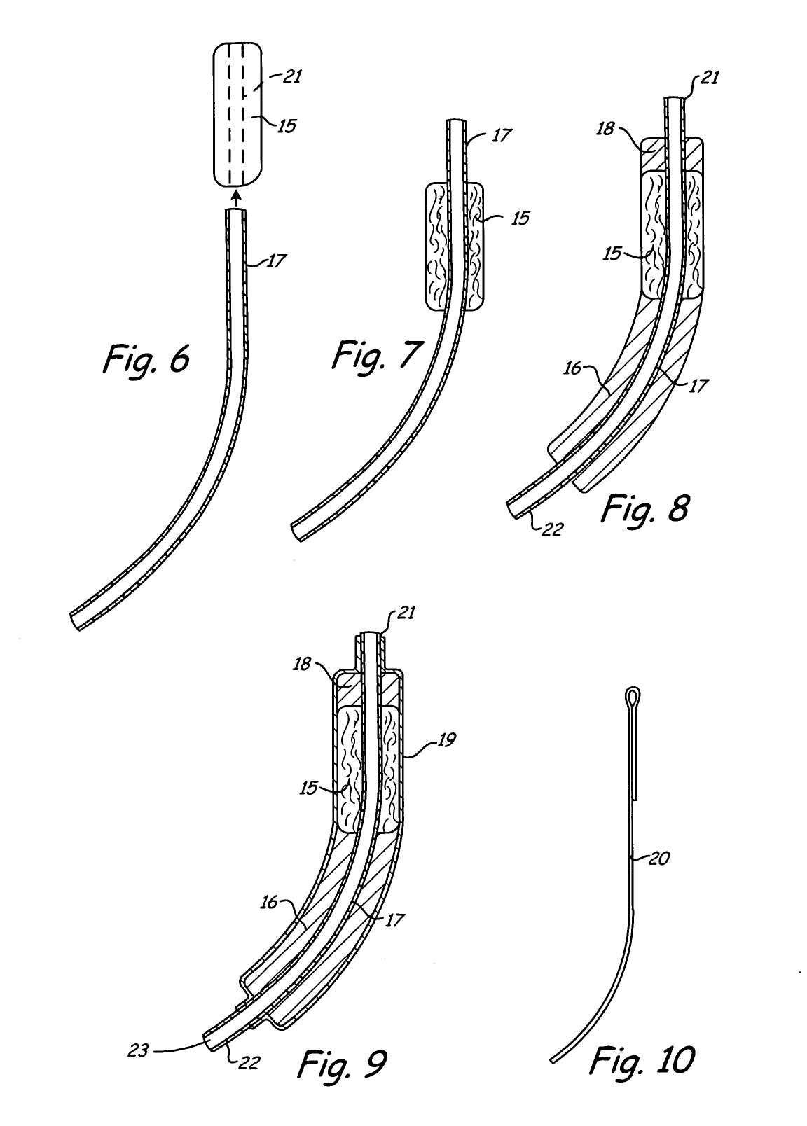

Having described the preferred embodiment of the sinker of the present invention, the method of making such a sinker is described as follows and with reference to FIGS. 6-10. The first step includes providing a tubular member 17 such as that shown in FIG. 6 and surrounding it with buoyant material 15 such as that shown in FIG. 7. This tubular member can be preformed as in FIG. 6 or, if desired, or if necessary, can be provided with a wire member 20 such as that shown in FIG. 10. If such a wire member 20 is used, it is inserted into the tubular member 17 and functions to assist in maintaining the desired shape or curvature of the tubular member 17 and to keep the center opening of the tubular member 17 open when the tubular member is exposed to the molten lead as described below. In the preferred method of making the sinker of the present invention, a wire 20 such as that shown in FIG. 10 is utilized. Preferably, the tubular member 17 of FIG. 6 is longer than the ending length of the sinker.

As shown in FIG. 6, a piece of buoyant material 15 is positioned around the member 17 by inserting one end of the tubular member 17, preferably the top or rod end, through a center opening 21 in the buoyant material 15. During this insertion step, the tubular member 17 is inserted through the buoyant member 15 to the position shown in FIG. 7. Because the length of the member 17 is longer than the end sinker, an extended portion extends beyond the end of the buoyant material 15.

Next, a further portion of the member 17 is surrounded by the weighted potions 16 and 18 by inserting the structure of FIG. 7, including the tubular member 17, the buoyant material 15 and the wire 20, if utilized into a mold. Antimony/lead or other weighted material is then introduced into the mold, in molten form and molded to the tubular member 17 and the ends of the buoyant material 15. Preferably, the mold is a silicon mold, although other molds and various molding techniques can be utilized. During this molding step, the two weighted portions 16 and 18 are cast at the same time. Preferably, a portion 21 of the tubular member 17 at the rod end of the body extends outwardly from the mold and the weighted portion 18. Similarly, the weighted portion 16 is preferably molded so that a portion 22 at the bottom end of the tubular member 19 extends outwardly from the mold and outwardly from the weighted portion 16. Depending upon the size of the mold cavity relative to the buoyant portion 15, it is possibly for some of the weighted material to flow around the edges of the buoyant portion 15 and for a limited distance along its sides.

After the weighted portions 16 and 18 have solidified, the sinker is removed from the mold and is hung via the wire 20 or an exposed portion of the tubular member 17. The sinker may then be provided with finishing dips and/or coatings. These dips and/or coatings can comprise one or more vinyl or other material dipping steps for the purpose of providing a coating 19 and one or more dips or applications of paint or finishes as desired. This results in the structure shown in FIG. 9. Following the dipping and painting process, the end portions 21 and 22 of the tubular member 19 extending beyond the rod end 12 and bait end 14 of the body are removed.

Although the description of the preferred embodiment and process has been quite specific, it is contemplated that various modifications could be Made without deviating from the spirit of the present invention. Accordingly, it is intended that the scope of the present invention be dictated by the appended claims rather than by the description of the preferred embodiment.

1. A fishing sinker comprising:
a body having first and second ends and comprising a weighted portion having a density greater than the density of water and a buoyant portion having a density less than the density of water; and
a fishing line receiving opening extending through said body from said first end to said second end.

2. The fishing sinker of claim 1 wherein said first end is a rod end and said second end is a bait end.

3. The fishing sinker of claim 2 wherein said weighted portion is a first weighted portion positioned at said bait end.

4. The fishing sinker of claim 3 including a second weighted portion having a density greater than the density of water positioned at said rod end, said second weighted portion being smaller than said first weighted portion.

5. The fishing sinker of claim 4 including a coating applied over substantially the entirety of said body.

6. The fishing sinker of claim 5 wherein said body is elongated and curved.

7. The fishing sinker of claim 6 wherein the fishing sinker is of unitary construction.

8. The fishing sinker of claim 7 wherein said center opening comprised a hollow tubular member extending through said first and second weighted portion and through said buoyant portion from said rod end to said bait end.

9. The fishing sinker of claim 1 wherein said center opening comprises a hollow tubular member extending from said first end to said second end.

10. The fishing sinker of claim 9 wherein said body is elongated and curved.

11. The fishing sinker of claim 10 wherein the fishing sinker is of unitary construction.

12. The fishing sinker of claim 11 wherein said buoyant portion is constructed of balsa wood.

13. The fishing sinker of claim 1 being a center slide slip sinker.

14. A method for making a fishing sinker comprising:
providing an elongated tubular member of a desired configuration;
surrounding a first portion of said tubular member with a buoyant portion having a density less than the density of water; and
surrounding a second portion of said tubular member with a weighted portion having a density greater than the density of water wherein said buoyant portion and said weighted portion are adjacent to one another.

15. The method of claim 14 wherein the step of providing an elongated tubular member includes inserting a wire member into said tubular member.

16. The method of claim 14 wherein the step of surrounding a first portion includes inserting an end of said tubular member through a piece of buoyant material.

17. The method of claim 16 wherein the step of surrounding a second portion includes positioning at least said second portion in a mold and pouring the material of said weighted portion, in a molten state, around said second portion.

18. The method of claim 14 wherein the step of surrounding a second portion includes positioning at least said second portion in a mold and pouring the material of said weighted portion, in a molten state, around said second portion.

19. The method of claim 14 wherein said weighted portion is a first weighted portion and the method includes surrounding a third portion of said tubular member with a second weighted portion having a density greater than the density of water, said buoyant portion positioned between said first and second weighted portions.

20. The method of claim 17 wherein said weighted portion is a first weighted portion and the method includes surrounding a third portion of said tubular member with a second weighted portion having a density greater than the density of water, said buoyant portion positioned between said first and second weighted portions and wherein the step of surrounding a third portion includes positioning at least said third portion in a mold and pouring the material of said second weighted portion, in a molten state, around said third portion.
